(19) United States
(12) Patent Application Publication
(10) Pub. No.: US 2024/0389071 A1
(43) Pub. Date: Nov. 21, 2024

(54) METHODS, DEVICES, AND MEDIUM FOR COMMUNICATION

(71) Applicant: NEC CORPORATION, Minato-ku (JP)

(72) Inventor: Gang WANG, Beijing (CN)

(73) Assignee: NEC CORPORATION, Tokyo (JP)

(21) Appl. No.: 18/696,540

(22) PCT Filed: Sep. 29, 2021
(86) PCT No.: PCT/CN2021/121664

§ 371 Date: Mar. 28, 2024

(51) Int. Cl. H04W 68/02; H04W 60/04; H04W 76/28

(52) U.S. Cl. CPC H04W 68/02; H04W 60/04; H04W 76/28

(57) ABSTRACT

Example embodiments of the present disclosure relate to an effective mechanism for handing the scenario of discontinuous coverage. In this solution, the terminal device receives a first configuration indicating at least one first duration during which the terminal device is located within coverage of a network. Further, the terminal performs at least one of the following within the at least one first duration: performing a cell search, performing a measurement for cell re-selection, or monitoring a paging message. In this way, the unnecessary power/signalling consumption is reduced.

### FIELD

Embodiments of the present disclosure generally relate to the field of telecommunication, and in particular, to methods, devices, and medium for communication.

### BACKGROUND

In conventional wireless communication, a terminal device needs to perform measurements and monitor a paging message even when the terminal device is in an idle state. As for a core network (CN) device, the CN device is responsible for triggering a paging procedure for the terminal device and maintaining a registration state for the terminal device. Recently, a non-terrestrial network (NTN) has been proposed to provide wide area coverage. A NTN refers to networks or segments of networks using an airborne or space-borne vehicle to embark a transmission equipment relay node or base station or using radio frequency (RF) resources on board a satellite or unmanned aerial system (UAS) platform.

Currently, it is agreed to support discontinuous coverage in the NTN. In case that the terminal device is out of coverage of the network, if the terminal device and the CN device behave ordinary operation (such as, the terminal device performs the measurements and monitors the paging message, the CN device initiates the paging procedure), undesirable power/signaling consumption and unexpected registration state transition would be caused.

### SUMMARY

In general, example embodiments of the present disclosure provide solutions of communication. Embodiments that do not fall under the scope of the claims, if any, are to be interpreted as examples useful for understanding various embodiments of the disclosure.

In a first aspect, there is provided a method of communication. The method comprises: receiving, at a terminal device, a first configuration indicating at least one first duration during which the terminal device is located within coverage of a network. The method further comprises performing at least one of the following within the at least one first duration: performing a cell search, performing a measurement for cell re-selection, or monitoring a paging message.

In a second aspect, there is provided a method of communication. The method comprises: receiving, at a CN device, a second configuration indicating at least one second duration during which a terminal device is located within coverage of a network. The method further comprises clearing or invaliding a paging proceed factor (PPF) flag for the terminal device within the at least one second duration.

In a third aspect, there is provided a method of communication. The method comprises: determining, at an access network device serving a terming device, time information that the terming device is located within coverage of a network. The method further comprises transmitting, based on the determined time information a first configuration indicating at least one first duration to be used by the terminal device to the terminal device and, a second configuration indicating at least one second duration to be used by a CN device to the CN device.

In a fourth aspect, there is provided a terminal device. The terminal device includes a processing unit; and a memory coupled to the processing unit and storing instructions thereon, the instructions, when executed by the processing unit, causing the device to perform the method according to the first aspect.

In a fifth aspect, there is provided a CN device. The CN device includes a processing unit; and a memory coupled to the processing unit and storing instructions thereon, the instructions, when executed by the processing unit, causing the device to perform the method according to the second aspect.

In a sixth aspect, there is provided an access network device. The access network device includes a processing unit; and a memory coupled to the processing unit and storing instructions thereon, the instructions, when executed by the processing unit, causing the device to perform the method according to the third aspect.

In a seventh aspect, there is provided a computer readable medium having instructions stored thereon, the instructions, when executed on at least one processor, causing the at least one processor to carry out the method according to the first aspect.

In an eighth aspect, there is provided a computer readable medium having instructions stored thereon, the instructions, when executed on at least one processor, causing the at least one processor to carry out the method according to the second aspect.

In a ninth aspect, there is provided a computer readable medium having instructions stored thereon, the instructions, when executed on at least one processor, causing the at least one processor to carry out the method according to the third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example pattern for conventional power saving mode (PSM);

FIG. 2 illustrates an example communication environment in which example embodiments of the present disclosure can be implemented;

FIG. 3 illustrates a signaling chart illustrating a process for communication according to some embodiments of the present disclosure;

FIG. 4 illustrates an example of the at least one first duration or the at least one second duration;

FIG. 5 illustrates another signaling chart illustrating a process for communication according to some embodiments of the present disclosure;

FIG. 6 illustrates an example a process for maintaining the related timer;

FIG. 7 illustrates example correspondences between the first duration and the actual coverage duration;

FIG. 8 illustrates an example method performed by a terminal device according to some embodiments of the present disclosure;

FIG. 9 illustrates an example method performed by a CN device according to some embodiments of the present disclosure;

FIG. 10 illustrates an example method performed by an access network device according to some embodiments of the present disclosure; and

FIG. 11 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below:

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “core network device” /“CN device” refers to any device or entity that provides access and mobility management function, session management function (SMF), user plane function (UPF), etc. By way of example rather than limitation, the CN device may be a mobility management entity (MME), an AMF, a SMF, a UPF, etc. In other embodiments, the CN device may be any other suitable device or entity.

As used herein, the term “access network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As discussed above, the NTN is capable of providing wide network coverage. Currently, there may be different types of satellite (or UAS platform) in the NTN. Blow Table 1 illustrated the example types of satellite.

TABLE 1
Types of satellite/UAS platform

| | | | | Typical beam |
|---|---|---|---|---|
| Satellite/UAS Platforms | Altitude range | | Orbit | footprint size |
| Low-Earth Orbit (LEO) satellite | 300-1500 | km | Circular around the earth | 100-1000 km |
| Medium-Earth Orbit (MEO) | 7000-25000 | km | | 100-1000 km |
| satellite | | | | |
| Geostationary Earth Orbit | 35 786 | km | notional station keeping | 200-3500 km |
| (GEO) satellite | | | position fixed in terms of | |
| UAS platform (including | 8-50 km | | elevation/azimuth with | 5-200 km |
| HAPS) | (20 km for HAPS) | | respect to a given earth | |
| | | | point | |
| High Elliptical Orbit (HEO) | 400-50000 | km | Elliptical around the earth | 200-3500 km |
| satellite | | | | |

Further, the NTN typically features the following elements:
One or several sat-gateways that connect the NTN to a public data network;
   A GEO satellite is fed by one or several sat-gateways which are deployed across the satellite targeted coverage (e.g. regional or even continental coverage). We assume that UE in a cell are served by only one sat-gateway;
   A Non-GEO satellite served successively by one or several sat-gateways at a time. The system ensures service and feeder link continuity between the successive serving sat-gateways with sufficient time duration to proceed with mobility anchoring and hand-over.
A feeder link or radio link between a sat-gateway and the satellite (or UAS platform).
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
   A transparent payload: radio frequency filtering, frequency conversion and amplification. Hence, the waveform signal repeated by the payload is un-changed;
   A regenerative payload: radio frequency filtering, frequency conversion and amplification as well as demodulation/decoding, switch and/or routing, coding/modulation. This is effectively equivalent to having all or part of base station functions (e.g., gNB) on board the satellite (or UAS platform).
Inter-satellite links (ISL) optionally in case of a constellation of satellites. This will require regenerative payloads on board the satellites. ISL may operate in RF frequency or optical bands.
UEs are served by the satellite (or UAS platform) within the targeted service area.

Currently, The NTN has been developed to support scenarios of IoT and enhanced machine type communication (eMTC). Examples of IoT NTN are listed as below.
Scenario A: GEO based non-terrestrial access network;
Scenario B: LEO based non-terrestrial access network generating steerable beams (altitude 1200 km and 600 km);
Scenario C: LEO based non-terrestrial access network generating fixed beams whose footprints move with the satellite (altitude 1200 km and 600 km); and
Scenario D: MEO based non-terrestrial access network generating fixed beams whose footprints move with the satellite (altitude 10000 km).

As discussed above, it is agreed to support discontinuous coverage in the NTN. So far, both the terminal device and the CN device usually cannot well obtain the coverage state about the network. As a result, as for the CN device, the CN device would not aware that the terminal device is out-of-coverage and will still tries to initiate a necessary paging procedure for the terminal device. Such unavailable paging state caused by the discontinuous coverage is temporary and intermittent. However, the CN device cannot understand that the paging failure is due to the discontinuous coverage, and thus transitions the terminal device to a deregistered state. In this even, if the terminal device enters into the coverage of the network again and wants to communicate with the network, the terminal device has to perform initial registration or PDU establishment procedure.

As for the terminal device, as the terminal device cannot aware that the terminal device is out-of-coverage, the terminal device will continue performing measurements and monitoring the paging message.

It can be seen that undesirable power/signaling consumption and unexpected registration state transition are introduced at terminal device and the CN device as the scenario of discontinuous coverage has not been well handled.

Although there are some mechanisms that have been proposed for reducing undesirable power consumption/signaling overhead, these mechanisms cannot be applied to the scenario of discontinuous coverage. For example, conventional mechanisms for reducing undesirable power consumption/signaling overhead include discontinuous reception (DRX), extended discontinuous reception (eDRX), PSM and relaxed monitoring.

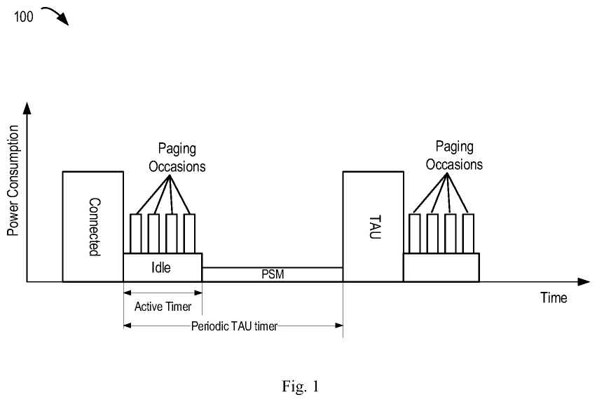

Reference is made to FIG. 1, which illustrates an example pattem 100 for conventional PSM. In the conventional solution illustrated in FIG. 1, if a UE is capable of adopting a PSM and it wants to use the PSM, the UE shall request an active time value and may request a periodic tracking area update (TAU) timer value during every attach and TAU procedures. Further, the UE shall not request a periodic TAU timer value if it is not requesting an active time value. Accordingly, the network shall not allocate an active time value if the UE has not requested the Active Time value.

If the network allocates an active time value, the UE and the MME starts the active timer with the active time value allocated by the network when transitioning from a connected mode to an idle mode. The UE shall stop the active timer, if running, when a transition to connected mode is made. When the active timer expires, the UE deactivates its access stratum functions and enters PSM. In PSM, due to deactivation of access stratum functions, the UE stops all idle mode procedures, but continues to run any non-access stratum timers that may apply, e.g. the periodic TAU timer.

Further, the UE shall resume access stratum functions and idle mode procedures before the periodic TAU timer expires for performing the periodic TAU procedure as applicable. The UE may resume idle mode procedures and access stratum functions any time while in PSM, e.g. for mobile originated communications. When the active timer expires for the UE, the MME knows that the UE entered PSM and is not available for paging.

It can be clearly seen that in the conventional solutions, the MME allocates a fix TAU timer value and a fix active time value without considering the coverage state of the network at all. Therefore, it is desirable to propose a solution for the scenario of the discontinuous coverage, such than the undesirable power consumption/signaling overhead may be reduced and the unexpected registration state transition may be avoided.

In order to solve the above and other potential problems, embodiments of the present disclosure provide an effective mechanism for handing the scenario of discontinuous coverage. In this solution, the terminal device and the CN device may obtain the information indicating the coverage of the network. With such information, the terminal device and the CN device may reduce undesirable power consumption/signaling.overhead and avoid the unexpected registration state transition.

Principle and example embodiments of the present disclosure will be described in detail below with reference to the accompanying drawings.

In the following, a satellite will be used as an example of an access network device for describing some specific example embodiments of the present disclosure. It is noted that example embodiments described with regard to the satellite are equally applicable to other type access network device.

In the following description, the terms “duration”, “window”, “period”, “interval” may be used interchangeably.

Term “at least one first duration” is introduced when describing a terminal device. Within the at least one first duration, the terminal device would consider that the terminal device is located in the coverage in the network. Similarly, term “at least one second duration” is introduced when describing a CN device. Within the at least one second duration, the CN device would consider that the terminal device is located in the coverage in the network.

It is noted that in this discourse, the above “at least one first duration” and “at least one second duration” are associated with the coverage state in the network and do not necessarily refer to the actual coverage state in the network.

Further, in some example embodiments, the “at least one first duration” is the same with the “at least one second duration”, while in some other example embodiments, the “at least one first duration” is different from the “at least one second duration”.

In addition, the terminal device may obtain the “at least one first duration” in a variety of manners. In one example embodiment, the terminal device obtains/collects information (such as, ephemeris, constellation almanac and the likes), and calculates/derives the at least one first duration locally. In another example embodiment, the terminal device 210 obtains the at least one first duration from a configuration (referred to as “a first configuration”) transmitted by other network device (such as, the access network device and the CN device).

In Addition, the procedure of obtaining “at least one second duration” by the CN device is analogues with that as discussed with regards to obtaining “at least one first duration” by the terminal device. Specifically, the CN device may calculates/derives the at least one second duration locally, or obtains the at least one second duration from a configuration (referred to as “a second configuration”) transmitted by other network device (such as, the access network device and the terminal device).

In this disclosure, the term “time information” is introduced when describing the access network device. The “time information” refers to the information associated with the coverage state of the network. As one specific example embodiment, the access network device collects information associated with the coverage information of its neighbor access network device(s) via a feeder link with the CN or an ISL with its neighbor access network device(s), and then determines the time information based on the collected information and the coverage information of itself.

It is noted that in this discourse, the “time information”, the “at least one first duration”, “at least one second duration”, the “first configuration” and the “second configuration” may be represented/indicated by any suitable manners/parameters.

Further, in this disclosure, the “time information”, the “at least one first duration” and “at least one second duration” also referred to as “serving time” /“serving window” sometimes.

### Example Environment

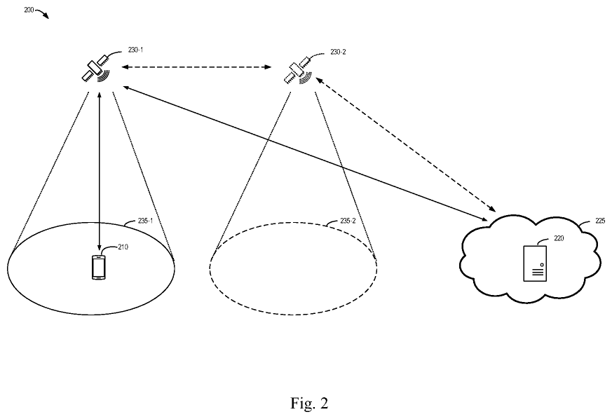

FIG. 2 shows an example communication environment 200 in which example embodiments of the present disclosure can be implemented. The network environment 200 includes a terminal device 210 and an access network device 230-1 serving the terminal device 210 and a further access network device 230-2. In the following text, the access network devices 230-1 and 230-2 are collectively referred to as the access network devices 230 or individually referred to as the network device 230. Additionally, on or more ISL may be established between the access network device 230-1 and the access network device 230-2.

Additionally, any of the access network devices 230-1 and 230-2 may provide one or more serving areas (also referred to as “cell” sometimes) to the terminal device 210. In the specific example of FIG. 2, the access network device 220-1 provides serving area 235-1 and the access network device 230-2 provides serving area 235-2. Serving area 235-1 and 235-2 hereinafter are collectively referred to as the serving areas 235 or individually referred to as a serving area 235.

In case that the terminal device is within a serving area 235 of the respective access network device 230, the terminal device 210 may communicate with the respective access network device 230 via such as a service link or radio link. Communication in a direction from a terminal device 210 towards the access network device 230 is referred to as uplink communication, while communication in a reverse direction from the access network device 230 towards the terminal device 210 is referred to as downlink communication.

In addition, in the specific example of FIG. 2, both the terminal device 210 and the access network device 230 may move over time. When moving, the terminal device 210 may be located in different serving areas 235 and also may be out of the coverage of the network sometimes.

In the specific example of FIG. 2, the terminal device 210 may be in different states (such as, connected state, inactive state and idle state) and also may operate on a power saving mechanism including but not limited to DRX, eDRX, PSM, relaxed monitoring and so on.

Further, the network environment 200 also comprises a CN 225. Further, the CN 225 may comprise a plurality of CN devices (such as, the CN device 220 as illustrated in FIG. 2). The access network device 230-1 and 230-2 may connect to the CN device 220 via such as feeder links or radio links.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of access network device, terminal device, CN device, CN and serving area are only for the purpose of illustration without suggesting any limitations. The communication environment 200 may include any suitable access network device, terminal device, CN device, CN and serving area adapted for implementing embodiments of the present disclosure. Although not shown, it is to be understood that one or more additional network devices may comprised in communication environment 200, such as, a terrestrial station, a gateway and so on.

### Example Processes

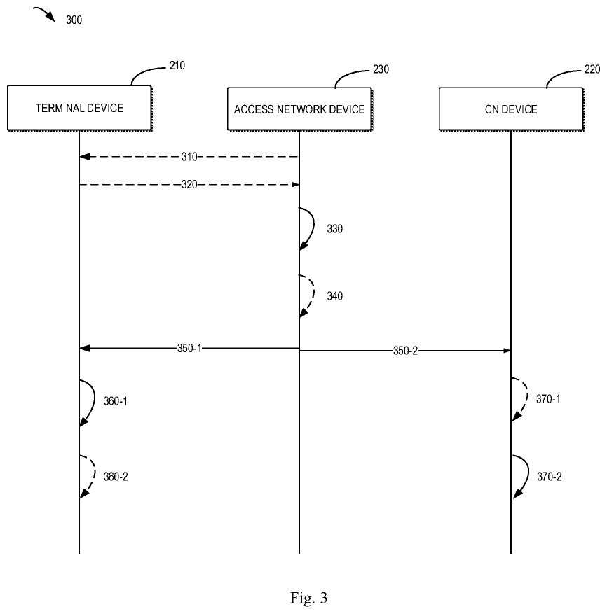

Principle and implementations of the present disclosure will be described in detail below with reference to FIG. 3. FIG. 3 shows a signaling chart illustrating a process 300 of communication according to some example embodiments of the present disclosure. For the purpose of discussion, the process 300 will be described with reference to FIG. 2. The process 300 may involve the terminal device 210, the CN device 220 and the access network device 230.

In the specific example of FIG. 3, the communicating network is a NTN supporting the discontinuous coverage. Further, the access network device 230 is a satellites or a UAS platform.

In operation, the terminal device 210 receives a first configuration indicating at least one first duration during which the terminal device 210 is located within the coverage of the network. In one example embodiment, the terminal device 210 receives 350-1 the first configuration from the access network device 230. In another example embodiment, the terminal device 210 receives the first configuration from the CN device 220.

It is to be understood that, alternatively, in some other example embodiments, the terminal device 210 may collect information associates with the coverage of the network and then calculates/derives the first duration by itself. In this way, the terminal device 210 may obtain the coverage information of the network.

Similarly, the CN device 220 also may receive 350-2 a second configuration indicating at least one second duration during which the terminal device 210 is located within the coverage of the network. In one example embodiment, the CN device 220 receives 330-2 the second configuration from the access network device 230. In another example embodiment, the CN device 220 receives the second configuration from the terminal device 210.

It is to be understood that, alternatively, in some other example embodiments, the CN device 220 may collect information associates with the coverage of the network and then calculates/derives the second duration by itself. In this way, the CN device 220 may obtain the coverage information of the network.

As discussed above, the first and the second configurations may be transmitted by the access network device 230. Specifically, the access network device 230 may determine 430 time information that the terming device 210 is located within the coverage of the network. Then the access network device 230 transmits the first configuration to the terminal device 210, while transmits the second configuration to the CN device 220.

Further, the access network device 230 may transmit the first and second configurations at any suitable occasions or in response to some pre-defined events. In one example embodiment, the access network device 230 transmits the first and second configurations in response to the terminal device 210 transitioning from a connected state to an idle mode (such as, a RRC idle state) (for example, the access network device 230 determines 340 that the terminal device 210 transitions into the RRC idle state). In another example embodiment, the access network device 230 transmits the first and second configurations when the terminal device is in the connected state (such as, the RRC connected state). It should be understood that the transition from the connected state to the idle mode are only for the purpose of illustration without suggesting any limitations. In other example embodiments, when the other power saving mechanism is operated in the network, the access network device 230 may transmits the first and second configurations in response to other suitable state transition. The present disclosure is not limited in this regard.

In some example embodiments, the access network device 230 conditionally transmits the first and second configurations. As one example embodiment, the access network device 230 transmits the first and second configurations only if the access network device 230 has received a first message for requesting the first configuration from the terminal device 210. Alternatively, in another example embodiment, the access network device 230 transmits the first and second configurations regardless whether the terminal device 210 request the first configuration.

In this way, the access network device 230 may inform the coverage information (i.e. the serving time) of the network to both the terminal device 210 and the CN device 220, such that the terminal device 210 and the CN device 220 may keep alignment on the reachability of terminal device 210.

Additionally, in some example embodiments, the access network device 230 determines the time information based on the information, such as, a velocity of the terminal device 210, a moving direction of the terminal device 210, a position of the terminal device 210, the ephemeris/constellation almanac of itself and the its neighbor access network device(s) and so on. In this way, the time information may be determined in a manner of being specific to a terminal device, and the accuracy of the determined time information is improved accordingly.

Additionally, this function/feature may be optional enabled or supported in the network. In some example embodiments, the access network device 230 transmits 310 an indication indicating that the access network device 230 supports to configure the first configuration. The indication may be used as capability information of the access network device 230, and further may be used as an indication to enable this function/feature in the network.

Further, the above indication may be transmitted in any suitable manner. In one example embodiment, the access network device 230 may transmit the indication in system information (SI) and via a broadcast manner.

In some example embodiments, the terminal device 210 also may transmit 320 a first message for requesting the first configuration to the access network device 230. Further, in some example embodiments, the terminal device 210 transmits the first message only if the terminal device 210 has received the indication indicating that the access network device 230 supports to configure the first configuration. In this way, this function/feature may be implemented as an optional function/feature and the terminal device 210 also may determine whether to enable function/feature.

Additionally, the first message may comprise one or more service characteristic or user preference. In one example embodiment, the first message comprises user preference information indicating an expected periodicity to communicate with the network. In this way, the first configuration generated for the terminal device 210 may be more reasonable.

As clarified above, the at least one first duration, the at least one second duration and the duration(s) corresponding to the time information do not necessarily refer to the actual coverage state in the network.

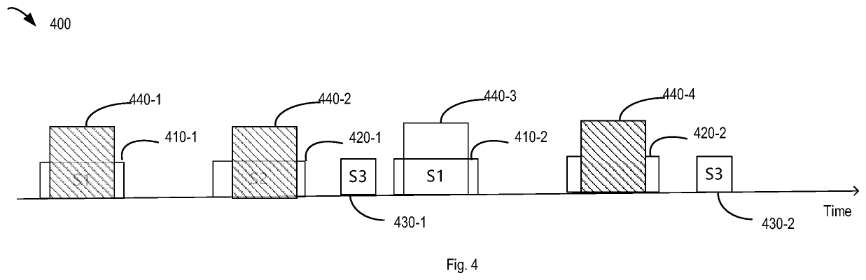

Reference is made to FIG. 4, which illustrates an example of the at least one first duration (or the at least one second duration). In the specific example of FIG. 4, three access network devices may provide serving areas in the network, such as, the access network device 230-1 (referred to as “S1” in FIG. 4), the access network device 230-2 (referred to as “S2” in FIG. 4) and the further access network device (referred to as “S3” in FIG. 4). Durations 410-1 and 410-2 correspond to the serving durations provided by the access network device 230-1, durations 420-1 and 420-2 correspond to the serving durations provided by the access network device 230-2, and durations 430-1 and 430-2 correspond to the serving durations provided by the further access network device. Further, the access network device 210-1 is serving the terminal device 210.

In the following, details about the at least one first duration will be discussion by referring to FIG. 4. In the specific example of FIG. 4, durations 440-1 to 440-4 are corresponding to the at least one first duration.

In some example embodiments, the at least one first duration may cover only part of the access network devices in the network. As illustrated in FIG. 4, the at least one first duration merely associates with the access network device 210-1 (i.e., S1) and the access network device 210-2 (i.e., S3).

It is to be understood that, alternatively, in some example embodiments, the at least one first duration merely associate with certain access network device (such as, the serving access network device 230-1).

In some example embodiments, the at least one first duration is periodic. In this event, the at least one first duration may be indicated by a periodicity of the at least one first duration, and a duration of each of the at least one first duration. Further, either the periodicity or the duration may be configured as a default value. If so, either the periodicity or the duration may be omitted when indicating the at least one first duration.

Alternatively, the at least one first duration is aperiodic. In this event, the at least one first duration may be indicated by information of several serving time in next period (such as, T hours, where T is larger than zero).

In some example embodiments, any of the at least one first duration may be provide either by a current serving access network device (such as, S1) or by its neighbor access network device (such as, S2 and S3). Further, each of first duration may be indicated by a starting time point and an ending time point.

It is to be understood that the above example embodiments of the at least one first duration are described only for the purpose of illustration. In other example embodiments, the at least one first duration may be any suitable manner (periodic or aperiodic) and may be represented/indicated by any suitable parameters.

The at least one second duration are similar with the at least one first duration. That is, the above description with regard to the first duration also be applicable to the at least one second duration. Merely for brevity, the same or similar descriptions are omitted here.

It is to be understood that the first duration and the second duration should be corresponding to each other, such that the operations at the terminal device 210 and the CN device may be consistent with each other. However, it is not required that the first duration strictly the same with the second duration. As discussed above, the at least one first duration and the at least one second duration may be different. In one example embodiment, at least one second duration has a longer length than the corresponding first duration.

Through the above processes, the network elements (including the terminal device 210, the CN device 220 and the access network device 230) may obtain the coverage state in the network. Then, the network elements may behave more power efficient and reasonable.

In some example embodiments, the terminal device 210 performs 360-1 the normal idle mode behavior within the at least one first duration, while disables 360-2 the normal idle mode behavior beyond the at least one first duration. One example of the normal idle mode behavior is performing a cell search. Another example of the normal idle mode behavior is performing a measurement for cell re-selection. A further example of the idle mode behavior is normal monitoring a paging message. In one specific example, the terminal device 210 implements the monitoring the paging message comprises: monitoring the downlink control information message first, and proceed with receiving the paging message based on the monitoring result.

In addition to the above examples, the normal idle mode behavior also may comprise but not limited to:
Monitoring system information (SI) updated and additionally to updated the SI based on the monitoring result;
Performing a sidelink communication transmission and reception;
Performing a sidelink discovery announcement and monitoring;
Performing a V2X sidelink communication transmission and reception;
Performing a NR sidelink communication transmission and reception;
V2X sidelink communication transmission and reception;
Performing a mobile originated early data transmission (MO-EDT);
Performing a mobile terminated early data transmission (MT-EDT);
Performing a transmission using reconfiguration uplink resource (PUR).

It should be understood that the above illustrated examples do not intent to exhaust the normal idle mode behavior, instead to make better understanding about the behavior that may be supported within the at least one first duration.

Additionally, the above procedure may be performed coordinately with other mechanism (such as, DRX, eDRX, PSM, relaxed monitoring and so on). In one example embodiment, the terminal device 210 monitors the paging messages using DRX and/or eDRX within the at least one first duration.

In this way, the unnecessary operation when the terminal device 210 is beyond the at least one device is avoided, and the power consumption at the terminal device 210 is reduced thereby.

As for the CN device 220 (such as, a MME), the CN device 220 may deduce 370-1 that the terminal device 210 is reachable within the at least one second duration, while deduce 370-2 that the UE is unreachable beyond the at least one second duration.

In some example embodiments, if the CN device 220 detects a paging failure within the at least one second duration (for example, the CN device 210 fails to receive a response for a paging message from the terminal device 210), the CN device 220 transmits a downlink data notification reject message to notify the SGW about the paging failure.

Alternatively, or in addition, in some example embodiments, if the CN device 220 detects a reachable timer (i.e., a timer corresponding to or similar with the periodic TAU timer) expires, the CN device 220 deduces that the UE is not reachable. Further, the CN device 220 does not immediately delete the bearers of the terminal device 210. Instead the CN device 220 clears the PPF flag in the CN device 220 and starts an implicit detach timer. If the implicit detach timer expires before the terminal device 210 contacts the network, the CN device 220 implicitly detaches the terminal device 210.

In some example embodiments, after receiving the second configuration, the CN device 210 directly indicates the SGW that the terminal device 210 will be unreachable for a period of time. That is, the CN device 220 informs the SGW of the interrupt of the coverage with the predicted suspend time for downlink data. The predicted suspend time may be determined based on the at least one second duration. Specifically, after receiving the second configuration, the CN device 220 transmits a first information indicating a first available time of the terminal device 210 for receiving downlink data to a SGW, where the first available time is determined based on the second configuration.

Alternatively, or in addition, in some example embodiments, the CN device 220 clears the PPF flag for the terminal device 210 beyond the at least one second duration. Alternatively, in some example embodiments, the CN device 220 does not clear the PPF flag, instead invalids the PPF flag for the terminal device 210 beyond the at least one second duration. In some example embodiments, the CN device 220 starts a timer (referred to as “timer A”), where when the timer expires, the CN device 22 may consider that the terminal device 210 is unreachable (i.e. being out of coverage). Additionally, when the timer A expires, the CN device 220 starts implicit detach timer.

In some example embodiments, if the CN device 220 receives a downlink data notification for the terminal device 210 from a SGW beyond the at least one second duration, the CN device 220 transmits a reject message for the downlink data notification to the SGW. Further, the reject message indicates the second available time (for example, be indicated by a value of a timer) of the terminal device 210 for receiving downlink data, where the second available time is determined based on the second configuration. For example, when the CN device 220 receives a downlink data notification message from the SGW beyond the second duration, the CN device 220 does not page the terminal device 210 and transmits a downlink data notification reject message with/including a configuration of Timer B (which indicates how long the terminal device 210 may be reachable again) to the SGW.

In this way, with the second duration, the CN device 220 may distinguish the different unreachable situations (such as, the situation caused by discontinuous coverage, the situation caused by other reasons (maybe the terminal device is switched off)). As a result, the CN device 220 may behaves differently upon detecting a paging failure or receiving a downlink data notification based on the second duration. Further, the terminal device 210 and the CN device 220 may keep alignment on the reachability between the terminal device 210 and the CN device 220, which avoids unnecessary power consumption caused by frequently performing initial registration when terminal device 210 returns back to coverage (i.e. avoid implicit detach operation when the terminal device is out of coverage due to the discontinuous serving).

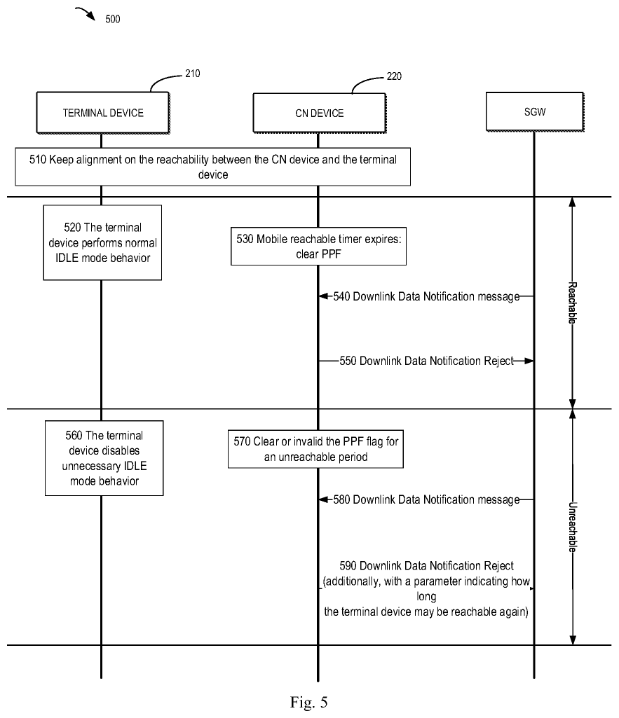

It is to be noted that the operations at the terminal device 210 and the operations at the CN device 220 should be consistent. Only for the purpose of illustration, one specific process will be described with reference to FIG. 5. FIG. 5 illustrates another signaling chart illustrating a process 500 for communication according to some embodiments of the present disclosure. For the purpose of discussion, the process 500 will be described with reference to FIG. 2. The process 500 may involve the terminal device 210, the CN device 220 and a SGW (not shown in FIG. 2).

In operation, the terminal device 210 and the CN device 220 keep 510 alignments on the reachability between each other. For example, the terminal device 210 has received the at least one first duration while the CN device 220 has received the at least one second duration.

Within the reachable duration (i.e., within the at least one first/second duration) the terminal device 210 performs 520 normal idle mode behavior as described above. As for the CN device 220, the CN device 220 maintains a mobile reachable timer based on the second duration. When the mobile reachable timer expires, the CN device 220 clears or invalids 530 the PPF for the terminal device 210. If the mobile reachable timer expires and the CN device 220 receives 540 a downlink data notification message from the SGW, the CN device 220 will responds 550 a downlink data notification reject message to the SGW. Further, if the mobile reachable timer does not expire, the terminal device 210 may be paged according to a common paging strategy.

Within the unreachable duration (i.e., beyond the at least one first/second duration) the terminal device 210 disables 560 unnecessary idle mode behavior. As for the CN device 220, the CN device 220 clears or invalids 570 the PPF flag for an unreachable period determined based on the at least one second duration. If the mobile reachable timer expires and the CN device 220 receives 580 a downlink data notification message from the SGW, the CN device 220 will responds 590 a downlink data notification reject message to the SGW, where the downlink data notification reject message may comprise a parameter indicating how long the terminal device 210 may be reachable again).

In the wireless communication, the network elements (including the terminal device 210, the CN device 220 and the access network device 230) may maintain one or more timers for controlling the communication in the network. In some example embodiments, the maintaining of the related timer(s) may also be improved according to the reachability/coverage information (i.e., serving time).

In some example embodiments, the terminal device 210 starts a first timer for controlling a communication with the network and further suspends the first timer beyond the at least one first duration. When the terminal device 210 is in an idle state, the first timer may be associated with a TAU timer. Alternatively, when the terminal device 210 is in a connected state, the first timer may be associated with an on duration timer (onDurationTimer), a discontinuous reception inactivity timer (drx-Inactivity Timer), a discontinuous reception retransmission timer (drx-RetransmissionTimer), or a discontinuous reception short cycle timer (drxShortCycleTimer).

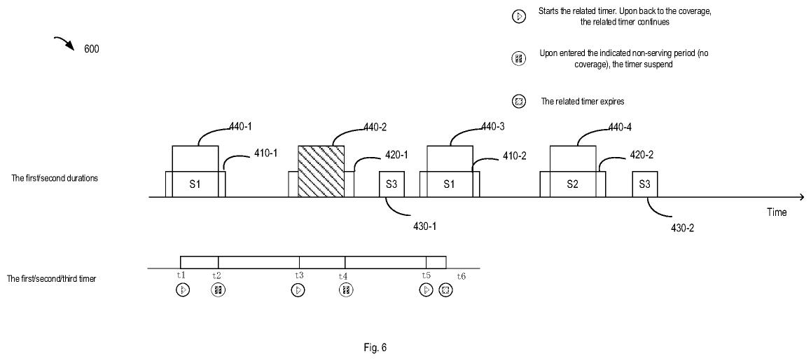

One specific example embodiment for maintaining the related timer is described with reference to FIG. 6. FIG. 6 illustrates an example a process 600 for maintaining the related timer. For the purpose of discussion, the process 600 will be described with reference to FIG. 4. The same reference numbers used in FIG. 6 have the same physical meaning with those illustrated in FIG. 4.

As illustrated in FIG. 6, the terminal device 210 starts the first timer at a time point t1. In one example embodiments, in case that the first timer is associates with the TAU timer, the terminal device 210 starts the first timer upon the terminal device 210 transitions from the connected state to the idle state.

Next, upon the terminal device 210 leaving the coverage of the network (i.e., beyond the first duration), the terminal device 210 suspends the first timer. In the specific example of FIG. 6, the terminal device 210 suspends the first timer at time points t2 and t4. Further, upon the terminal device 210 returning back to the coverage of the network again (i.e., within the first duration), the terminal device 210 resumes/continues the first timer. In the specific example of FIG. 6, the terminal device 210 resumes/continues the first timer at time points t3 and t5.

Then, at time point t6, the first timer expires, and the terminal device may trigger the corresponding operation, such as, initiating a TAU procedure.

As clarified above, the operations at the terminal device should be consistent with those at the network side. That is, if the maintaining procedure of the timer at the terminal device 210 is improved, the corresponding timer maintained by the access network device 230 and the CN device 220 should be improved accordingly.

Specifically, in some example embodiments, the CN device 220 starts a second timer for controlling a communication with the terminal device 210, and suspends the second timer beyond the at least one second duration. Additionally, in some example embodiments, the second timer is associated with a TAU timer (such as, a mobile reachable timer).

As for the access network device 230, in some example embodiments, the access network device 230 starts a third timer for controlling a communication with the terminal device 210 and suspends the third timer beyond the at least one duration corresponding to the at least one first duration. Additionally, in some example embodiments, the third timer is associated with an on duration timer (onDurationTimer), a discontinuous reception inactivity timer (drx-Inactivity Timer), a discontinuous reception retransmission timer (drx-RetransmissionTimer), or a discontinuous reception short cycle timer (drxShortCycleTimer).

The maintaining operation of the second timer and the third timer is similar with that of the first timer. For brevity, the same or similar descriptions are omitted here.

Further, as discussed above, both the terminal device 210 and the access network device 230 may move over time, which may cause that the determined time information/the first configuration/the second configuration unsuitable/invalid. According to some of the example embodiments of this disclosure, the determined time information/the first configuration/the second configuration may be dynamically updated.

In some example embodiments, the access network device 230 may determine the time information and transmits the first and second configurations to the terminal device 210 and the CN device 220 periodically.

Alternatively, in some example embodiments, the determined time information/the first configuration/the second configuration may be updated by some specific conditions.

In some example embodiments, if the terminal device 210 determines that the first configuration is at least partially invalid, the terminal device 210 transmits a second message for updating the first configuration to the access network device 230 serving the terminal device 210.

The second message may be transmitted to the access network device at any suitable occasions. In one example embodiment, the terminal device 210 initiates an access procedure to update the first configuration (i.e., transmitting the second message) upon returning back to coverage. In another example embodiment, the terminal device 210 initiates to update the first configuration when the terminal device 210 accesses to the network next time.

In some example embodiments, if the access network device 230 receives the second message for updating the first configuration from the terminal device 210, the access network device 230-1 determines updated time information for the terminal device 210. Then, the access network device 230-1 transmits an updated first configuration associated with the determined updated time information to the terminal device 210 and an updated second configuration associated with the determined updated time information to the CN device 220.

Additionally, the terminal device 210 may determine that the first configuration is at least partially invalid according any to any suitable criteria. In some example embodiments, the terminal device 210 determines that the first configuration is at least partially invalid if a moved distance of the terminal device 210 within an evaluation duration (referred to as “T_evaluate”) exceeds a distance threshold (referred to as “D_ref”). As one specific example embodiment, if the terminal device 210 finds that the distance from the reference point is larger/not smaller than the D_ref, the terminal device 210 deduces that the first configuration is not suitable any more, where the reference point is the location that the terminal device 210 receives the first configuration. In one specific example embodiment, the terminal device 210 evaluates this distance change at least every T_evaluate.

Alternatively, in some example embodiments, the terminal device 210 determines that the first configuration is at least partially invalid if a duration of the terminal device 210 failing to communicate with network (referred to as “T_difference”) within the one of the at least one of the first duration exceeds a time threshold (referred to as “T_ref”). In other words, if the T_difference within a first duration exceeds the T_ref, the terminal device 210 determines that the first configuration is at least partially invalid.

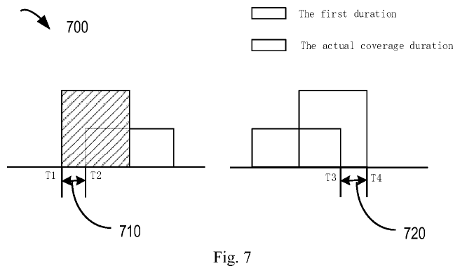

Reference is made to FIG. 7, which FIG. 7 illustrates example correspondences 700 between the first duration and the actual coverage duration.

As illustrated in FIG. 7, the first configuration indicates the coverage starts at a time point T1 and the actual measurement shows that the coverage start at time point T2. That is the actual coverage starts later than the expected. The time difference is represented as T_difference=T2−T1, i.e., time difference 710 as illustrated in FIG. 7. In this specific example, if the T_difference=T2−T1>T_ref, the terminal device 210 determines that the first configuration is at least partially invalid.

Additionally, as the terminal device 210 may know that the actual coverage starts later than the expected and further may determine the delayed duration (i.e., T_difference), the terminal device 210 may expand the first duration by T_difference. Further, the information of the T_difference also may be reported to the access network device 230 via such as the second message for updating the first configuration.

Still refer to FIG. 7, the first configuration indicates the coverage ends at time point T4, while the actual measurements shows that the coverage ends at time point T3. That is the actual coverage starts in advance. The time difference is represents as T_difference=T4−T3, i.e., time difference 720 as illustrated in FIG. 7. In this specific example, if the T_difference=T4−T3>T_ref, the terminal device 210 determines that the first configuration is at least partially invalid.

Additionally, the parameters and the criteria to be used by the terminal device to determine the validity of the first configuration may be configured by the access network device 230. For example, in some example embodiments, the access network device 230 transmits a third message to the terminal device 210, where the third message may comprise information indicating at least one of the following: a distance threshold, an evaluation duration and a time threshold.

It is to be understood that the above examples for determining whether the first configuration is at least partially invalid are only for the purpose of illustration without suggesting any limitations. In other example embodiments, the terminal device 210 may apply any suitable criterion to determine whether the first configuration is at least partially invalid. The present disclosure is not limited in this regard.

### Example Methods

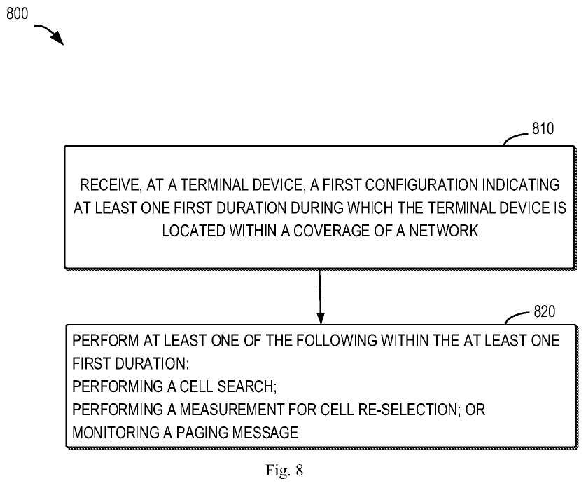

FIG. 8 illustrates a flowchart of an example method 800 in accordance with some embodiments of the present disclosure. For example, the method 800 can be implemented at the terminal device 210 as shown in FIG. 2.

At block 810, the terminal device 210 receives a first configuration indicating at least one first duration during which the terminal device 210 is located within coverage of a network.

At block 820, the terminal device 210 performs at least one of the following within the at least one first duration: performing a cell search, performing a measurement for cell re-selection, or monitoring a paging message.

In some example embodiments, the terminal device 210 disables at least one of the following beyond the at least one first duration: performing a cell search, performing a measurement for cell re-selection or monitoring a paging message.

In some example embodiments, the terminal device 210 receives, from an access network device 230 serving the terminal device 210, an indication indicating that the access network device 230 supports to configure the first configuration.

In some example embodiments, the terminal device 210 transmits, to an access network device 230 serving the terminal device 210, a first message for requesting the first configuration

In some example embodiments, the first message comprises user preference information indicating an expected periodicity to communicate with the network.

In some example embodiments, the at least one first duration is periodic, and the first configuration indicates one of the following: a periodicity of the at least one first duration, or a duration of each of the at least one first duration.

In some example embodiments, the terminal device 210 starts a first timer for controlling a communication with the network, and suspends the first timer beyond the at least one first duration.

In some example embodiments, the first timer is associated with one of the following: a tracking area update timer (TAU timer), an on duration timer (onDurationTimer), a discontinuous reception inactivity timer (drx-Inactivity Timer), a discontinuous reception retransmission timer (drx-RetransmissionTimer), or a discontinuous reception short cycle timer (drxShortCycleTimer).

In some example embodiments, the terminal device 210 determines that the first configuration is at least partially invalid, and transmits a second message for updating the first configuration to an access network device 230 serving the terminal device 210.

In some example embodiments, the terminal device 210 determines that the first configuration is at least partially invalid if a moved distance of the terminal device 210 within an evaluation duration exceeds a distance threshold.

In some example embodiments, the terminal device 210 determines that the first configuration is at least partially invalid if a duration of the terminal device 210 failing to communicate with network within the one of the at least one of the first duration exceeds a time threshold.

In some example embodiments, the terminal device 210 receives, from the access network device 230, a third message comprising information indicating at least one of the following: the distance threshold, the evaluation duration, or the time threshold.

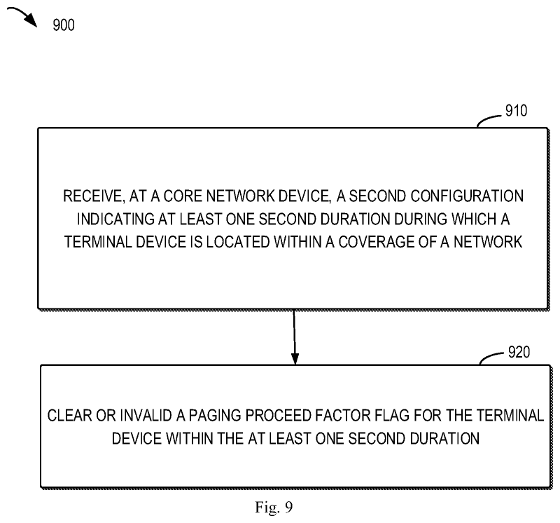

FIG. 9 illustrates a flowchart of an example method 900 in accordance with some embodiments of the present disclosure. For example, the method 900 can be implemented at the CN device 220 as shown in FIG. 2.

At block 910, the CN device 220 receives a second configuration indicating at least one second duration during which a terminal device 210 is located within coverage of a network.

At block 920, the CN device 220 clears or invalids a paging proceed factor flag for the terminal device 210 within the at least one second duration.

In some example embodiments, the at least one second duration is periodic resource, and the second configuration indicates one of the following: a periodicity of the at least one second duration, or a duration of each of the at least one second duration.

In some example embodiments, after receiving the second configuration, the CN device 220 transmits a first information indicating a first available time of the terminal device 210 for receiving downlink data to a SGW based on the second configuration.

In some example embodiments, upon receiving a downlink data notification for the terminal device 210 from a serving gateway beyond the at least one second duration, the CN device 220 transmits a reject message for the downlink data notification to the SGW. The reject message indicates the second available time of the terminal device 210 for receiving downlink data. The second available time is determined based on the second configuration.

In some example embodiments, the CN device 220 starts a second timer for controlling a communication with the terminal device 210, and suspends the second timer beyond the at least one second duration.

In some example embodiments, the second timer is associated with a tracking area update timer (TAU timer).

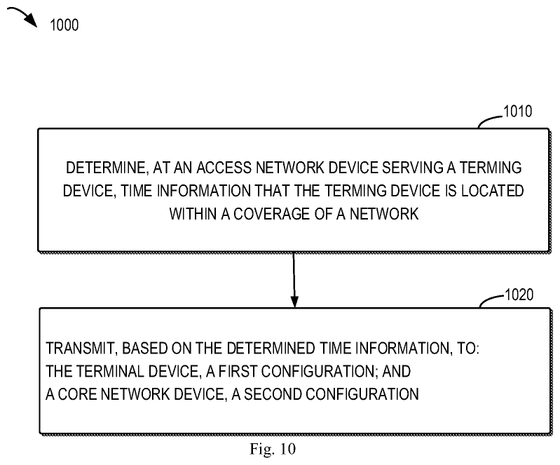

FIG. 10 illustrates a flowchart of an example method 1000 in accordance with some embodiments of the present disclosure. For example, the method 1000 can be implemented at the access network device 230 as shown in FIG. 2.

At block 1010, the access network device 230 serving a terming device determines time information that the terming device is located within coverage of a network.

At block 1020, the access network device 230 transmits, based on the determined time information, a first configuration indicating at least one first duration to be used by the terminal device 210 to the terminal device 210 and a second configuration indicating at least one second duration to be used by the CN device 220 a CN device 220.

In some example embodiments, the access network device 230 transmits an indication indicating that the access network device 230 supports to configure the first configuration to the terminal device 210.

In some example embodiments, the access network device 230 receives a first message for requesting the first configuration from the terminal device 210.

In some example embodiments, the first message comprises user preference information indicating an expected periodicity to communicate with the network. The access network device 230 determines the time information based on the user preference information.

In some example embodiments, the access network device 230 receives a second message for updating the first configuration from the terminal device 210, determines updated time information for the terminal device 210, and transmits an updated first configuration associated with the determined updated time information to the terminal device 210 and an updated second configuration associated with the determined updated time information to the CN device 220.

In some example embodiments, the access network device 230 transmits, to the terminal device 210, a third message comprising information to be used by the terminal device 210 to determine the validity of the first configuration, the information indicating at least one of the following: a distance threshold, an evaluation duration, or a time threshold.

In some example embodiments, the access network device 230 transmits the first configuration and the second configuration in response to the terminal device 210 transitioning from a connected state to an idle state.

In some example embodiments, the access network device 230 starts a third timer for controlling a communication with the terminal device 210, and suspends the third timer beyond the at least one duration corresponding to the at least one first duration.

In some example embodiments, the third timer is associated with one of the following: an on duration timer (onDurationTimer), a discontinuous reception inactivity timer (drx-Inactivity Timer), a discontinuous reception retransmission timer (drx-RetransmissionTimer), or a discontinuous reception short cycle timer (drxShortCycleTimer).

### Example Devices

In some example embodiments, the terminal device 210 comprises circuitry configured to receive a first configuration indicating at least one first duration during which the terminal device 210 is located within coverage of a network, and perform at least one of the following within the at least one first duration: performing a cell search, performing a measurement for cell re-selection or monitoring a paging message.

In some example embodiments, the circuitry is further configured to disable at least one of the following beyond the at least one first duration: performing a cell search, performing a measurement for cell re-selection, or monitoring a paging message.

In some example embodiments, the circuitry is further configured to receive an indication indicating that the access network device 230 supports to configure the first configuration from an access network device 230 serving the terminal device 210.

In some example embodiments, the circuitry is further configured to transmit a first message for requesting the first configuration to an access network device 230 serving the terminal device 210.

In some example embodiments, the first message comprises user preference information indicating an expected periodicity to communicate with the network.

In some example embodiments, the at least one first duration is periodic, and the first configuration indicates one of the following: a periodicity of the at least one first duration or a duration of each of the at least one first duration.

In some example embodiments, the circuitry is further configured to start a first timer for controlling a communication with the network, and suspend the first timer beyond the at least one first duration.

In some example embodiments, the first timer is associated with one of the following: a tracking area update timer (TAU timer), an on duration timer (onDurationTimer), a discontinuous reception inactivity timer (drx-Inactivity Timer), a discontinuous reception retransmission timer (drx-RetransmissionTimer), or a discontinuous reception short cycle timer (drxShortCycleTimer).

In some example embodiments, the circuitry is further configured to determine that the first configuration is at least partially invalid, and transmit a second message for updating the first configuration to an access network device 230 serving the terminal device 210.

In some example embodiments, the circuitry is further configured to determine that the first configuration is at least partially invalid if a moved distance of the terminal device 210 within an evaluation duration exceeds a distance threshold.

In some example embodiments, the circuitry is further configured to determine that the first configuration is at least partially invalid if a duration of the terminal device 210 failing to communicate with network within the one of the at least one of the first duration exceeds a time threshold.

In some example embodiments, the circuitry is further configured to receive, from the access network device 230, a third message comprising information indicating at least one of the following: the distance threshold, the evaluation duration, or the time threshold.

In some example embodiments, the CN device 220 comprises circuitry configured to receive a second configuration indicating at least one second duration during which a terminal device 210 is located within coverage of a network, and clear or invalid a paging proceed factor flag for the terminal device 210 within the at least one second duration.

In some example embodiments, the at least one second duration is periodic resource, and the second configuration indicates one of the following: a periodicity of the at least one second duration or a duration of each of the at least one second duration.

In some example embodiments, the circuitry is further configured to transmit a first information indicating a first available time of the terminal device 210 for receiving downlink data to a serving gateway after receiving the second configuration based on the second configuration.

In some example embodiments, the circuitry is further configured to upon receiving a downlink data notification for the terminal device 210 from a serving gateway beyond the at least one second duration, transmit a reject message for the downlink data notification to the serving gateway: The reject message indicates the second available time of the terminal device 210 for receiving downlink data, the second available time being determined based on the second configuration.

In some example embodiments, the circuitry is further configured to start a second timer for controlling a communication with the terminal device 210, and suspend the second timer beyond the at least one second duration.

In some example embodiments, the second timer is associated with a tracking area update timer (TAU timer).

In some example embodiments, the access network device 230 serving a terming device comprises circuitry configured to determines time information that the terming device is located within coverage of a network, and transmit a first configuration indicating at least one first duration to be used by the terminal device 210 to the terminal device 210, based on the determined time information and a second configuration indicating at least one second duration to be used by the CN device 220 to a CN device 220.

In some example embodiments, the circuitry is further configured to transmit, to the terminal device 210, an indication indicating that the access network device 230 supports to configure the first configuration.

In some example embodiments, the circuitry is further configured to receive, from the terminal device 210, a first message for requesting the first configuration.

In some example embodiments, the first message comprises user preference information indicating an expected periodicity to communicate with the network. The circuitry is further configured to determine the time information based on the user preference information.

In some example embodiments, the circuitry is further configured to receive, from the terminal device 210, a second message for updating the first configuration, determine updated time information for the terminal device 210, and transmit an updated first configuration associated with the determined updated time information to the terminal device 210, and an updated second configuration associated with the determined updated time information to the CN device 220.

In some example embodiments, the circuitry is further configured to transmit, to the terminal device 210, a third message comprising information to be used by the terminal device 210 to determine the validity of the first configuration, the information indicating at least one of the following: a distance threshold, an evaluation duration, or a time threshold.

In some example embodiments, the circuitry is further configured to transmit the first configuration and the second configuration in response to the terminal device 210 transitioning from a connected state to an idle state.

In some example embodiments, the circuitry is further configured to start a third timer for controlling a communication with the terminal device 210, and suspend the third timer beyond the at least one duration corresponding to the at least one first duration.

In some example embodiments, the third timer is associated with one of the following: an on duration timer (onDurationTimer), a discontinuous reception inactivity timer (drx-Inactivity Timer), a discontinuous reception retransmission timer (drx-RetransmissionTimer), or a discontinuous reception short cycle timer (drxShortCycleTimer).

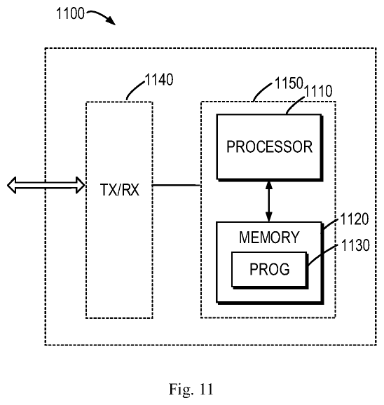

FIG. 11 is a simplified block diagram of a device 1100 that is suitable for implementing embodiments of the present disclosure. The device 1100 can be considered as a further example implementation of the terminal device 210, the access network device 230 and the CN device 220 as shown in FIG. 2. Accordingly, the device 1100 can be implemented at or as at least a part of the terminal device 210, the access network device 230 and the CN device 220.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2-10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 and 4-18. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A method, performed by a network device, comprising:
receiving, from a terminal device, a first configuration related with a duration, wherein the terminal device is assumed as unreachable within the duration;
clearing a paging proceed flag, corresponding to the duration.)

32. The method of claim 31, further comprising:
adjusting a mobile reachable timer, corresponding to the duration.

33. The method of claim 31, further comprising:
transmitting a second configuration to indicate a predicted suspend time, wherein the predicted suspend time is determined based on the duration.

34. The method of claim 31, wherein
the network device is an access and mobility management function (AMF).

35. A method, performed by a terminal device, comprising:
transmitting, to a network device, a first configuration related with a duration, wherein the terminal device is assumed as unreachable within the duration;
disabling monitoring a paging message, corresponding to the duration.

36. The method of claim 35, further comprising:
receiving a second duration related with extended discontinuous reception (eDRX), wherein the second duration is determined based on time information related with the duration.

37. The method of claim 35, further comprising:
transmitting a message for updating the duration, in a case where the first configuration is invalid.

38. The method of claim 35, wherein
a predicted suspend time is determined based on the duration.

39. A network device, comprising a processor configured to cause the network device to:
receive, from a terminal device, a first configuration related with a duration, wherein the terminal device is assumed as unreachable within the duration;
clear a paging proceed flag, corresponding to the duration.

40. The network device of claim 39, the processor being configured to cause the network device to:
adjust a mobile reachable timer, corresponding to the duration.

41. The network device of claim 39, the processor being configured to cause the network device to:
transmit a second configuration to indicate a predicted suspend time, wherein the predicted suspend time is determined based on the duration.

42. The network device of claim 39, wherein
the network device is an access and mobility management function (AMF).

43. A terminal device, comprising a processor configured to cause the terminal device to:
transmit, to a network device, a first configuration related with a duration, wherein the terminal device is assumed as unreachable within the duration;
disable monitoring a paging message, corresponding to the duration.

44. The terminal device of claim 43, the processor configured to cause the terminal device to:
receive a second duration related with extended discontinuous reception (eDRX), wherein the second duration is determined based on time information related with the duration.

45. The terminal device of claim 43, the processor configured to cause the terminal device to:
transmit a message for updating the duration, in a case where the first configuration is invalid.

46. The terminal device of claim 43, wherein
a predicted suspend time is determined based on the duration.
